(19) United States
(12) Patent Application Publication
(10) Pub. No.: US 2025/0078005 A1
(43) Pub. Date: Mar. 6, 2025

(54) DECISION ENGINE FOR COMPUTING SYSTEM ENERGY MANAGEMENT

(71) Applicant: Accenture Global Solutions Limited, Dublin (IE)

(72) Inventors: Vibhu Saujanya SHARMA, Bangalore (IN); Vikrant KAULGUD, Pune (IN); Rohit MEHRA, Delhi (IN); Priyavanshi PATHANIA, Chandigarh (IN); Sanjay PODDER, Thane (IN); Adam Patten BURDEN, Tampa, FL (US)

(21) Appl. No.: 18/597,479

(22) Filed: Mar. 6, 2024

(30) Foreign Application Priority Data
Mar. 10, 2023 (IN) 202341015968

(51) Int. Cl. G06Q 10/0637; G06N 20/00; G06Q 10/0639

(52) U.S. Cl. CPC G06Q 10/06375; G06N 20/00; G06Q 10/06393

(57) ABSTRACT

In some implementations, a device may receive information identifying a computing system for energy management, the computing system having a set of hardware components, a set of virtual machines, and a set of software entities. The device may generate a digital twin of the computing system for simulation of the set of hardware components, the set of virtual machines, and the set of software entities. The device may determine, using the digital twin of the computing system, a set of energy consumption metrics, for the computing system, associated with a set of candidate parameters. The device may generate, using a recommendation engine, one or more recommendations for the computing system based on the set of energy consumption metrics associated with the set of candidate parameters. The device may transmit information associated with identifying the one or more recommendations.

### BACKGROUND

Data centers and other computing facilities, such as cloud computing environments, have become more widespread across a variety of industries. Data centers are used for storing, processing, and/or managing large amounts of data generated by businesses, governments, and/or individuals. The rapid growth of data centers has led to a significant increase in energy consumption. For example, data centers consume vast amounts of energy due to power servers, cooling systems, networking devices, and other components used to keep data centers operational. Other computing systems, such as cloud computing systems, may have similar components with large energy consumption requirements.

The high energy consumption of data centers has led to several environmental and economic concerns. For example, data centers may be responsible for significant amounts of greenhouse gas emissions, resulting in a significant carbon footprint for the businesses, governments, and/or individuals that manage the data centers. Furthermore, the cost of energy for operating data centers can be substantial and, as data centers continue to grow in size and complexity, an amount of energy that data centers consume is expected to increase significantly.

### SUMMARY

Some implementations described herein relate to a method. The method may include receiving, by a device, information identifying a computing system for energy management, the computing system having a set of hardware components associated with first energy information, a set of virtual machines associated with second energy information, and a set of software entities associated with third energy information. The method may include generating, by the device, a digital twin of the computing system using the first energy information for simulation of the set of hardware components, the second energy information for simulation of the set of virtual machines, and the third energy information for simulation of the set of software entities. The method may include determining, by the device and using the digital twin of the computing system, a set of energy consumption metrics, for the computing system, associated with a set of candidate parameters. The method may include generating, by the device and using a recommendation engine, one or more recommendations for the computing system based on the set of energy consumption metrics associated with the set of candidate parameters. The method may include transmitting, by the device, information associated with identifying the one or more recommendations.

Some implementations described herein relate to a device for wireless communication. The device may include a memory and one or more processors coupled to the memory. The one or more processors may be configured to receive information identifying a computing system for energy management, the computing system having a set of hardware components associated with first energy information, a set of virtual machines associated with second energy information, and a set of software entities associated with third energy information. The one or more processors may be configured to generate a digital twin of the computing system using the first energy information for simulation of the set of hardware components, the second energy information for simulation of the set of virtual machines, and the third energy information for simulation of the set of software entities. The one or more processors may be configured to determine, using the digital twin of the computing system, a set of energy consumption metrics, for the computing system, associated with a set of candidate parameters. The one or more processors may be configured to generate, using a recommendation engine, one or more recommendations for the computing system based on the set of energy consumption metrics associated with the set of candidate parameters. The one or more processors may be configured to transmit information associated with implementing the one or more recommendations.

Some implementations described herein relate to a non-transitory computer-readable medium that stores a set of instructions for wireless communication. The set of instructions, when executed by one or more processors of a device, may cause the device to receive information identifying a computing system for energy management, the computing system having a set of hardware components associated with first energy information, a set of virtual machines associated with second energy information, and a set of software entities associated with third energy information. The set of instructions, when executed by one or more processors of the device, may cause the device to generate a digital twin of the computing system using the first energy information for simulation of the set of hardware components, the second energy information for simulation of the set of virtual machines, and the third energy information for simulation of the set of software entities. The set of instructions, when executed by one or more processors of the device, may cause the device to determine, using the digital twin of the computing system, a set of energy consumption metrics, for the computing system, associated with a set of candidate parameters. The set of instructions, when executed by one or more processors of the device, may cause the device to generate, using a recommendation engine, one or more recommendations for the computing system based on the set of energy consumption metrics associated with the set of candidate parameters. The set of instructions, when executed by one or more processors of the device, may cause the device to determine a set of updated energy consumption metrics associated with the set of candidate parameters based on the one or more recommendations. The set of instructions, when executed by one or more processors of the device, may cause the device to select a particular recommendation, from the one or more recommendations, based on the set of updated energy consumption metrics. The set of instructions, when executed by one or more processors of the device, may cause the device to transmit information identifying the particular recommendation.

### BRIEF DESCRIPTION OF THE DRAWINGS

FIGS. 1A-1H are diagrams of an example implementation associated with energy management for computing systems.

FIG. 2 is a diagram illustrating an example of training and using a machine learning model in connection with energy management for computing systems.

FIG. 3 is a diagram of an example environment in which systems and/or methods described herein may be implemented.

FIG. 4 is a diagram of example components of a device associated with energy management for computing systems.

FIG. 5 is a flowchart of an example process associated with energy management for computing systems.

### DETAILED DESCRIPTION

The following detailed description of example implementations refers to the accompanying drawings. The same reference numbers in different drawings may identify the same or similar elements.

Various techniques have been developed to address issues in energy consumption in computing systems, such as data centers, cloud computing systems, decentralized ledger computations (e.g., crypto-currency mining), among other examples. For example, computing systems can be connected to electrical grids that use renewable energy sources, can have high-efficiency cooling systems installed, can have energy-efficient hardware, or can repurpose generated heat (e.g., for use in building heating). As further examples, computing systems can have different sets of parameters (e.g., processing parameters) configured and/or can schedule tasks for off-peak energy utilization periods. Accordingly, usage of different computing systems for different tasks and/or usage of a single computing system with different parameters can result in different energy consumptions and/or associated carbon footprints. Similarly, siting choices for computing systems (e.g., where to establish a data center or which physical hardware to use to support a cloud computing environment) can have a significant impact on the energy consumption and/or associated carbon footprint for a computing system.

An assessment of computing system energy utilization can be performed to identify different energy consumption values from different operating scenarios. However, translating computing system energy assessments into actionable decisions regarding siting, configuration, or other options may be inaccurate as a result of a lack of consideration to the vast array of different options. For example, computing systems may generate thousands or millions of different configuration or siting options, some of which may correlate with energy consumption, from thousands, millions, or billions of different data points associated with computing systems.

Some implementations described herein enable use of a decision engine for management of computing system energy consumption. For example, an energy management system may determine energy consumption information associated with hardware components, virtual machines, and/or software elements of a computing system, and may use the energy consumption information to generate a digital twin of the computing system. Using the digital twin, the energy management system can simulate different sets of candidate parameters for the computing system and generate recommendations for energy management of the computing system based on simulations of the different sets of candidate parameters. In this way, the energy management system provides more accurate recommendations for reducing or offsetting energy consumption by a computing system, which improves configuration of a data center (e.g., by enabling reduced energy consumption for the data center), budgeting for computing tasks (e.g., by reducing costs associated with energy consumption), and/or siting of data centers (e.g., by identifying relative carbon footprints of different siting options).

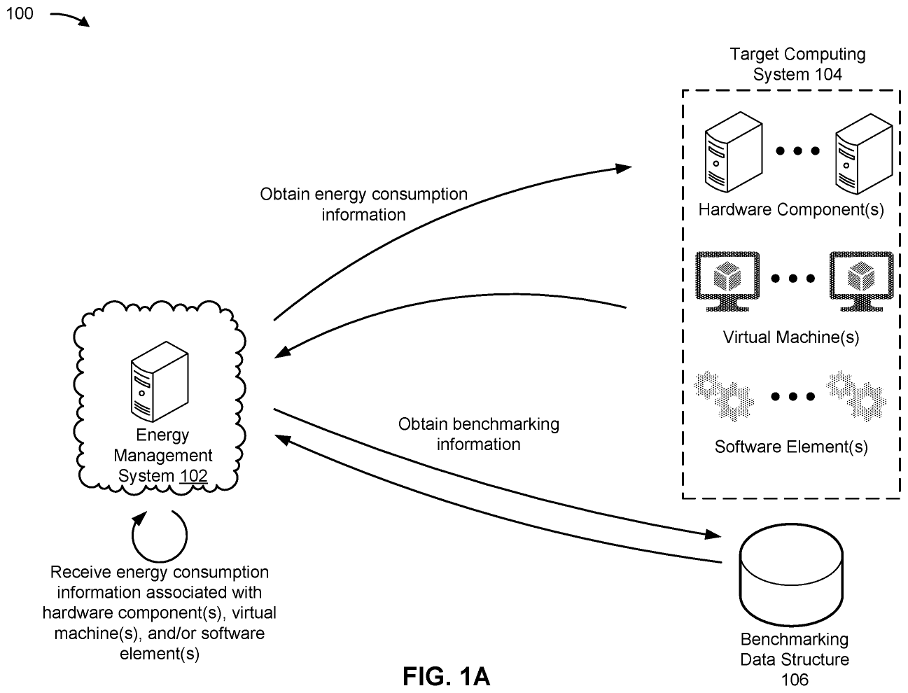

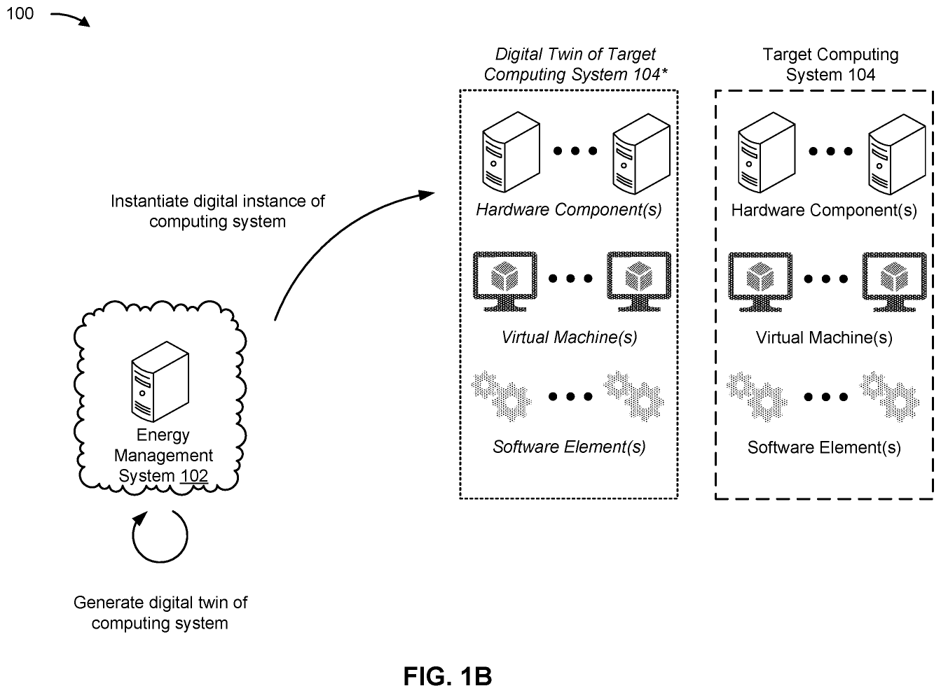

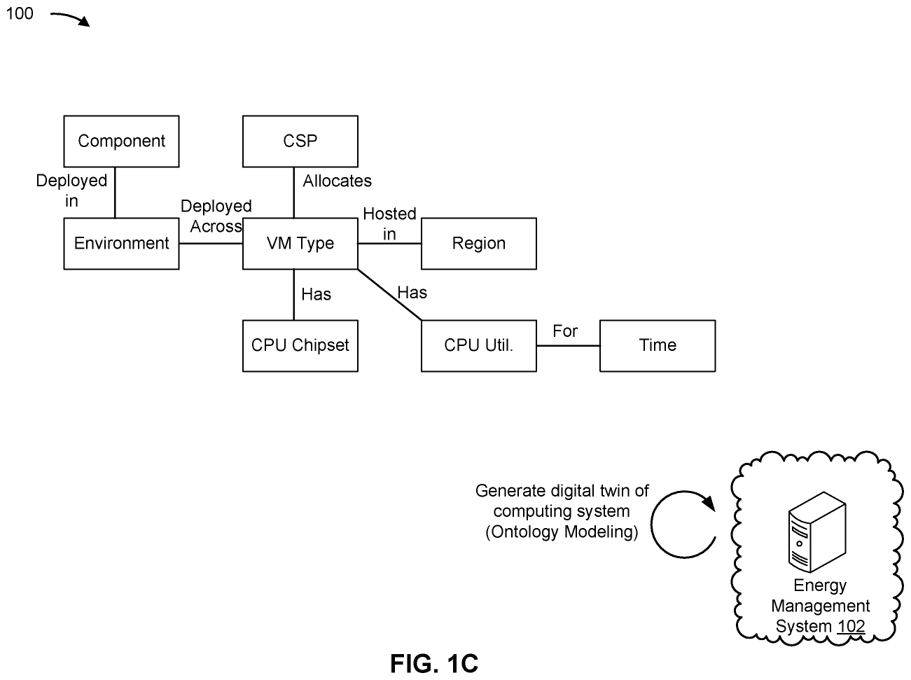

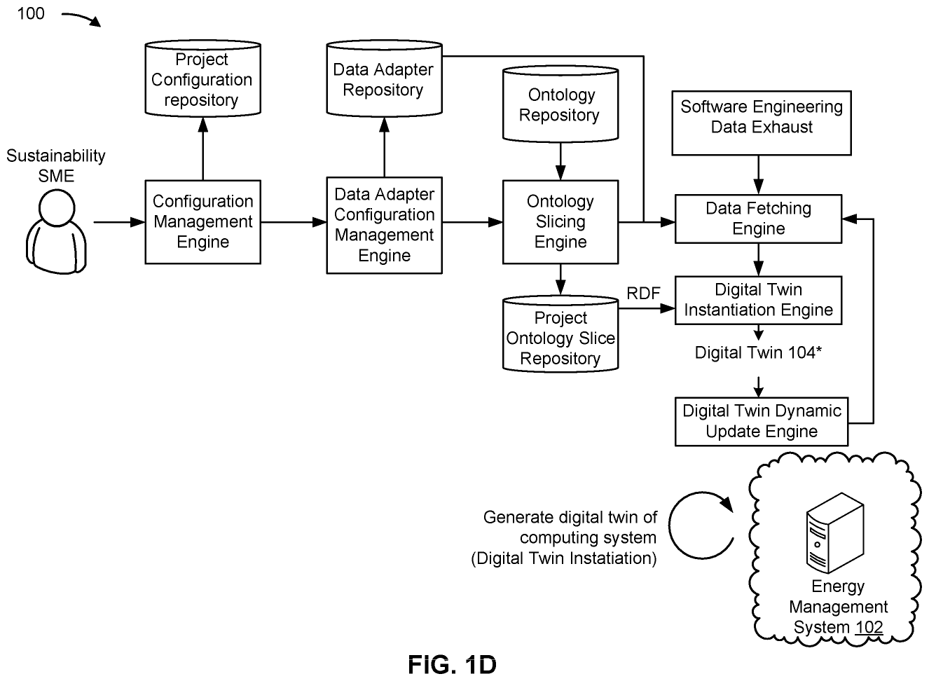

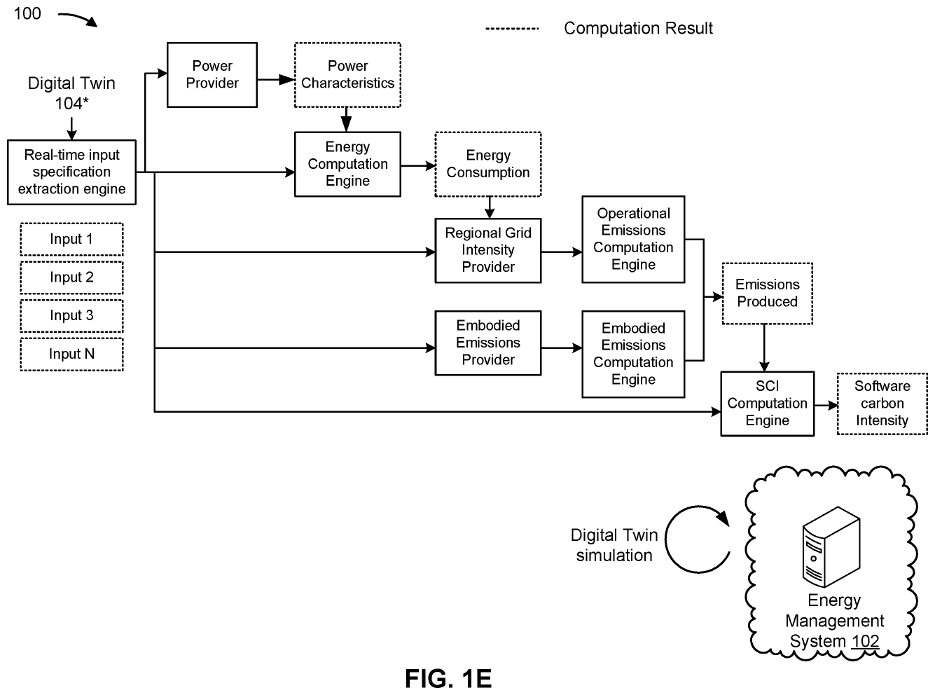

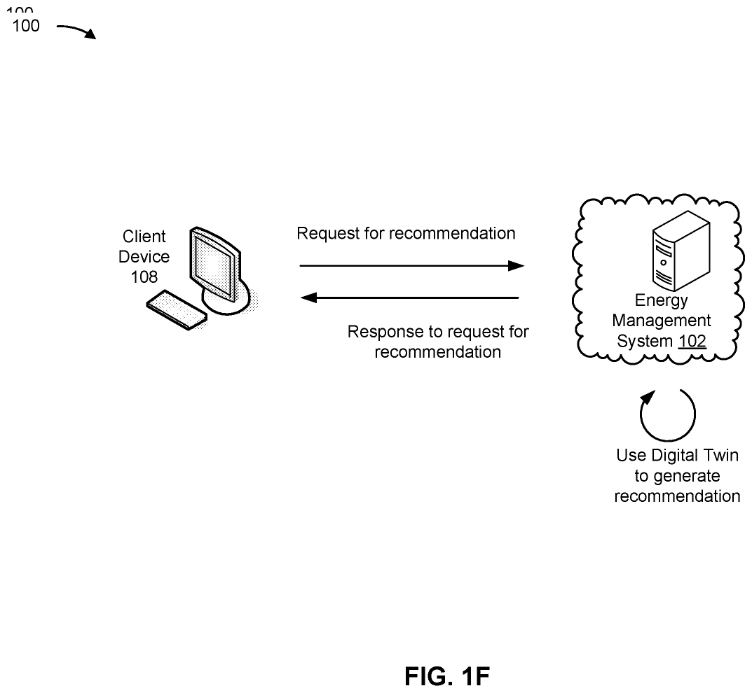

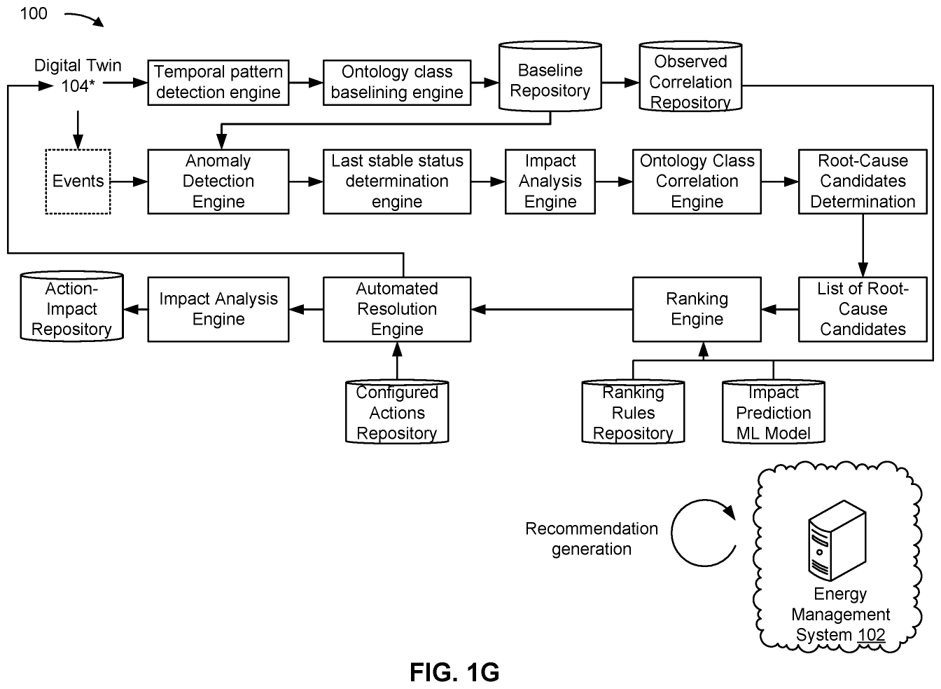

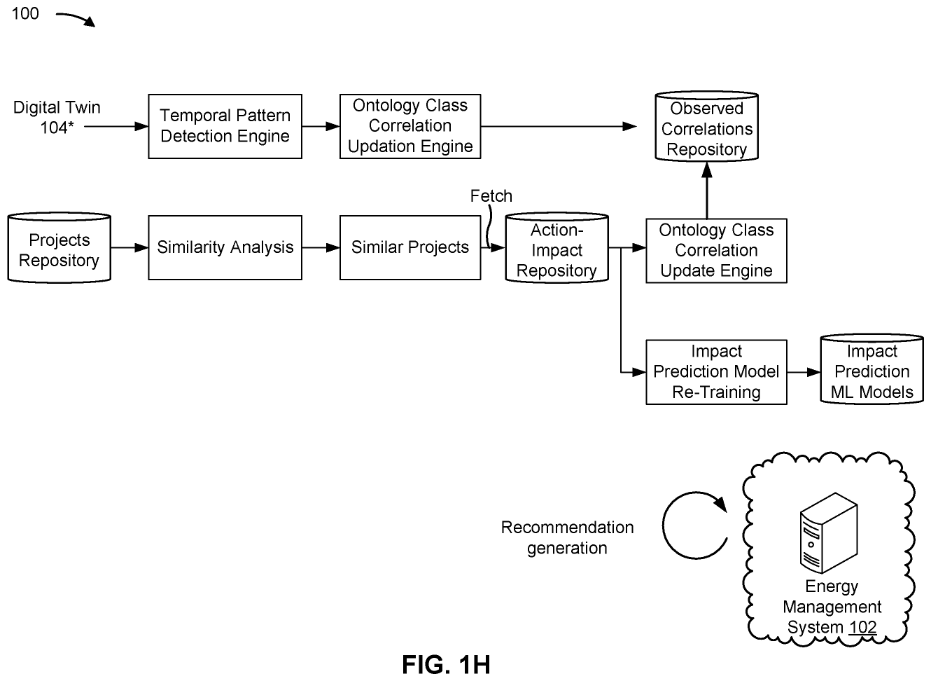

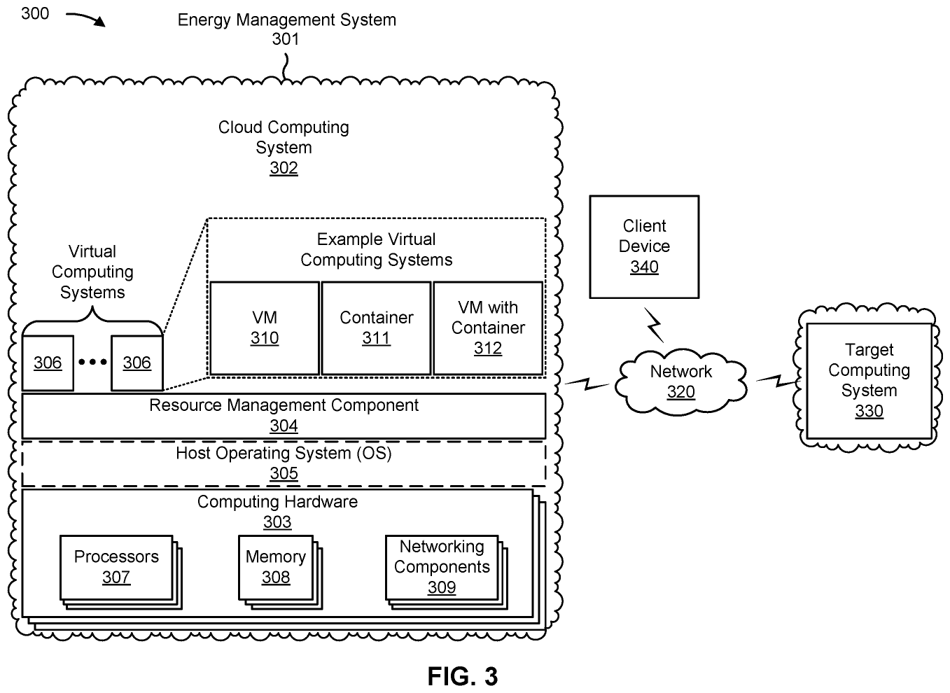

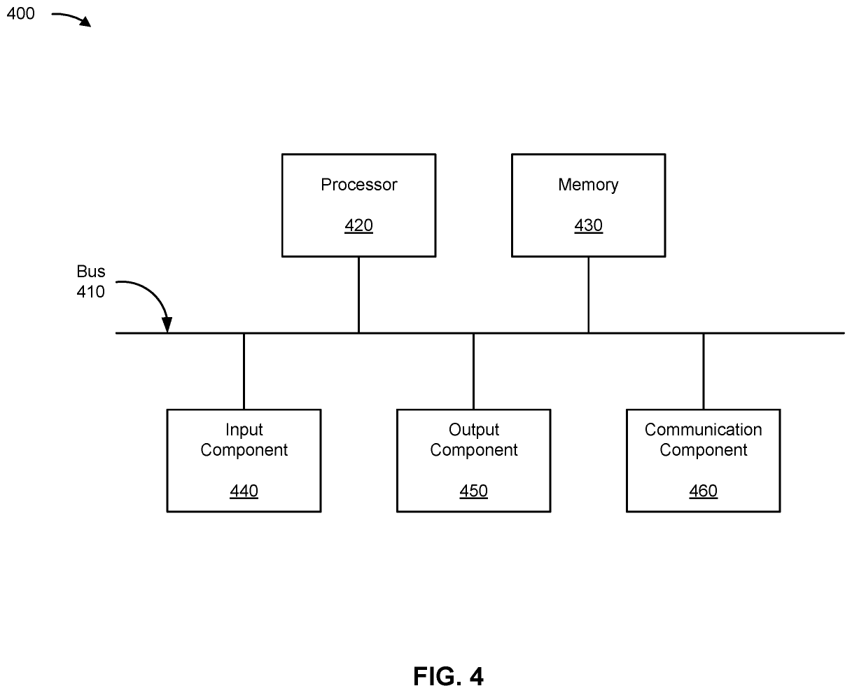

FIGS. 1A-1H are diagrams of an example implementation 100 associated with energy management for computing systems. As shown in FIGS. 1A-1H, example implementation 100 includes an energy management system 102, a target computing system 104, a benchmarking data structure 106, and a client device 108. These devices are described in more detail below in connection with FIG. 3 and FIG. 4.

As shown in FIG. 1A, the energy management system 102 may receive energy consumption information associated with a set of hardware components, virtual machines, or software elements of the target computing system 104. For example, the energy management system 102 may obtain hardware component information from the target computing system 104 and/or hardware benchmarking information from a benchmarking data structure 106. The hardware component information may include information identifying a set of hardware components of the target computing system 104 and/or a set of parameters or configurations thereof. The hardware benchmarking information may include information regarding the set of hardware components, such as an energy consumption of a hardware component, a quantity of virtual machines that can be supported by a hardware component, or a type of computing task that can be executed by a hardware component, among other examples. As an example, types of computing tasks that may have different energy consumptions for hardware associated therewith include blockchain tasks, token mining tasks, streaming video tasks, data center processing tasks, or parallel computing tasks, among other examples.

Some examples of energy consumption information associated with hardware components may include information identifying a hardware vendor, a model, a form factor, a central processing unit (CPU) name, a CPU characteristic, a CPU frequency, a quantity of CPUs that are enabled, a quantity of hardware threads, a cache size, a memory size, a power supply rating, a power supply model, a disk drive model, a network interface card (NIC) model, a quantity of NICs enabled in firmware, a network speed, a set of peripherals, a measured performance, a rated performance (e.g., a target load, an actual load, an average active power, or a power-to-performance ratio, among other examples), a benchmark test result (e.g., results of executing one or more computing tasks on a particular hardware type or configuration), a power characteristic, a performance characteristic, or a deployment type, among other examples.

In some implementations, the energy management system 102 may access a set of different benchmarking data structures 106 to obtain hardware component information. For example, the energy management system 102 may communicate with the target computing system 104 to identify a first manufacturer of a first hardware component (e.g., a server) and a second manufacturer of a second hardware component (e.g., a NIC) and may access respective benchmarking data structures 106 for the first manufacturer and the second manufacturer to obtain information regarding the first hardware component and the second hardware component, respectively.

Additionally, or alternatively, the virtual machine energy consumption information may include information identifying a set of virtual machines of the target computing system 104 and/or a set of parameters or configurations thereof. The virtual machine benchmarking information may include information regarding the set of virtual machines, such as an energy consumption associated with a virtual machine, a quantity of software elements that can be supported by a virtual machine, or a type of computing task that can be executed by a virtual machine, among other examples.

Additionally, or alternatively, the software element energy consumption information may include information identifying a set of software elements of the target computing system 104 and/or a set of parameters or configurations thereof. The software element benchmarking information may include information regarding the set of software elements, such as an energy consumption of a software element, dependencies between software elements (e.g., hardware components, virtual machines, or other software elements that are to be available or operating in connection with a particular software element), or a type of computing task that can be executed by a software element, among other examples.

As shown in FIG. 1B, the energy management system 102 may generate a digital twin of the target computing system 104. For example, the energy management system 102 may instantiate a digital twin 104*, which is a digital twin of the target computing system 104. A digital twin may represent a virtual replica of a physical target computing system (e.g., a physical data center or a cloud computing environment), including hardware components (e.g., which may include network components), software elements, and/or virtual machines. The digital twin is generated using the energy consumption information (e.g., which may include real-time data collected from various sensors and devices). The digital twin enables the energy management system 102 to monitor and optimize the performance of the target computing system in real-time, as well as simulate different scenarios to plan for potential issues or changes. For example, the energy management system 102 can use a digital twin 104* to test an impact of adding new equipment or changing a configuration of the target computing system 104, as described in more detail herein, without risking any downtime or other disruptions.

As shown in FIG. 1C, to generate the digital twin 104*, the energy management system 102 may model an ontology of the target computing system 104. For example, the energy management system 102 may generate a formal representation of entities, relationships, and concepts that make up the physical system being simulated. In this case, to model an ontology of the target computing system 104, the energy management system 102 may define a set of rules and a vocabulary that describes the different components (e.g., hardware components, virtual machines, and/or software elements) and behaviors (e.g., energy consumption) of the target computing system 104 in a way that can be understood and interpreted by the energy management system 102. The ontology model serves as a foundation for the digital twin 104*, providing a standardized and structured way to organize and analyze data collected from or determined regarding the target computing system 104.

As further shown in FIG. 1C, the ontology of the target computing system 104 may include a description of a hardware component that is deployed in an environment, which is deployed across a virtual machine (VM) type. The virtual machine type includes (“has”) resources allocated from a cloud service provider (CSP) and is hosted in a particular region (e.g., a particular cloud and/or a particular physical location for hardware resources, such as a particular data center). The virtual machine type includes a particular central processing unit (CPU) chipset for a CPU hosting the virtual machine type and a particular CPU utilization to host the virtual machine type. The particular CPU utilization occurs for a particular period of time, which may represent an amount of uptime that is configured for the virtual machine type. In other words, the ontology represents a set of formal relationships between hardware components, virtual machines, and/or software elements of the target computing system 104. As another example, a file (e.g., deployed in the target computing system 104) may be part of a release for a component (e.g., which is deployed in an environment as described above). As another example, the file may include a package, which includes a class, which includes a set of methods and calls. Other properties that may be defined in the ontology for an entity (e.g., a hardware component, a virtual machine, or a software element) include a power curve (e.g., an estimation of power utilization of a virtual machine on a per unit basis, such as a per percentage of CPU utilization basis)) or an energy consumption (e.g., an estimation of a utilization and/or source of energy for a CPU on a per CPU utilization unit basis, such as a per time basis), among other examples.

As shown in FIG. 1D, to generate the digital twin 104*, the energy management system 102 may instantiate the digital twin 104* of the target computing system 104. For example, the energy management system 102 may use a configuration management engine to configure a project for the digital twin 104* and store the configured project in a project configuration repository. In this case, the project may have a set of associated parameters, such as information identifying an energy calculation tool, a cloud discovery tool (e.g., for parsing a cloud instance), a version control system, or a carbon intensity data provider tool, among other examples. The energy management system 102 may use a data adapter configuration management engine to generate a data adapter for parsing data associated with the ontology for the target computing system 104 and to store the data adapter in a configured data adapter repository. In this case, the data adapter may have a set of associated parameters, such as a uniform resource locator (URL) address for the data adapter, a set of credentials for accessing data repositories and/or the target computing system 104, a set of tokens, a set of data tags, or a set of properties, among other examples. The energy management system 102 may use an ontology slicing engine to process the generated ontology and generate a set of project ontology slices. In this case, the project has a set of associated ontology slices representing different sub-sections of the ontology (e.g., different hardware components, software elements, or virtual machines).

The energy management system 102 may use a data fetching engine to obtain data from a software engineering data exhaust pipeline and adapt the data using the data adapter, which is obtained from the data adapter repository. The energy management system 102 generates an instance of the digital twin 104* using the obtained and adapted data as inputs for a state of the digital twin 104* and using a digital twin dynamic update engine to dynamically adjust the digital twin 104* based on real-time data from the target computing system 104 (e.g., in a monitoring case) or based on simulated data from the digital twin 104* itself (e.g., in a simulation case). In some implementations, the energy management system 102 may use the digital twin dynamic update engine to update the digital twin 104* on an event basis. For example, the energy management system 102 may update the digital twin 104* when a new computing task is started. Additionally, or alternatively, the energy management system 102 may update the digital twin 104* on a periodic basis, such as based on a timer expiring.

As shown in FIG. 1E, the energy management system 102 may perform a digital twin simulation. For example, based on instantiating the digital twin 104* and using the digital twin dynamic update engine to ensure that data is input into the digital twin 104*, the energy management system 102 may perform an emission metric estimation using the digital twin 104*. In this case, the energy management system 102 uses a real-time input specification extraction engine to identify a set of inputs to the target computing system 104 to simulate for the digital twin 104*, such as inputs relating to a power provider, a regional grid intensity, an emissions calculation for a regional grid, or a carbon intensity associated with energy for the regional grid. As shown, the energy management system 102 may determine a set of power characteristics based on a power provider for the target computing system 104 and determine an energy consumption using an energy computation engine based on the set of power characteristics.

The energy management system 102 may determine a regional grid intensity provider and compute operational emissions associated with the target computing system 104 using an operational emissions computation engine. Similarly, the energy management system 102 may determine an embodied emissions provider and determine embodied emissions using an embodied emissions computation engine. Based on the embodied emissions and the operational emissions, the energy management system 102 may determine total emissions associated with the target computing system 104 (e.g., using the digital twin 104* to simulate projected operation of the target computing system 104).

Operational emissions may include direct emissions that occur during the operation of target computing system 104 as simulated using the digital twin 104*. For example, operational emissions include greenhouse gas emissions from combustion of fuels for energy generation (if using fossil fuel based power) for the target computing system 104. In contrast, embodied emissions may include indirect emissions associated with the production and consumption of goods and services. Embodied emissions include emissions that occur during the extraction, processing, manufacturing, and transportation of, for example, the energy used in the target computing system 104. In other words, operational emissions can include emissions from burning coal for power generation and may be dependent on an efficiency of a power plant and a power delivery system, whereas embodied emissions can include emissions from mining of the coal (e.g., which may be dependent on a source of the coal and an efficiency of a coal transport infrastructure), emissions from the production of solar panels (e.g., including both mining of materials and manufacture), or emissions from production of the hardware that is being used for the target computing system 104).

Based on the emissions produced and/or one or more other inputs, the energy management system 102 may use a software carbon intensity (SCI) computation engine to determine a software carbon intensity associated the target computing system 104. For example, the energy management system 102 may determine the software carbon intensity based on an equation SCI=((E×I)+M)/R, where SCI is the software carbon intensity, E is the energy consumption, I is the regional grid intensity (e.g., in terms of carbon emissions per energy unit), M is the embodied emissions, and R is configuration parameter. In this case, using the digital twin 104*, the energy management system 102 may recalculate the software carbon intensity and/or other energy consumption metrics for different sets of candidate parameters or use contexts. For example, the energy management system 102 may recalculate the software carbon intensity when siting a target computing system 104 at a different location (e.g., with a different energy mix), when using a different set of hardware components to support the target computing system 104 (e.g., with different energy consumption values), or when configuring a virtual machine or software element with different configuration parameters (e.g., a different uptime, a different resource utilization, or a different order of computing tasks for completion), among other examples.

As shown in FIG. 1F, the energy management system 102 may receive a request for a determination relating to the energy consumption. For example, the client device 108 may transmit a request for a recommendation relating to the target computing system 104. In this case, the energy management system 102 may use the energy consumption information to identify a recommendation and may transmit a response to the client device 108. Additionally, or alternatively, the energy management system 102 may generate the recommendation autonomously (e.g., based on monitoring the target computing system 104 and/or the digital twin 104*) and may provide the recommendation to the client device 108 or automatically implement the recommendation.

In some implementations, the energy management system 102 may identify an energy optimization for the target computing system 104. For example, the energy management system 102 may benchmark an energy consumption of the target computing system 104, and may use the benchmarked energy consumption to identify a change to a parameter to reduce the energy consumption.

Additionally, or alternatively, the energy management system 102 may select the target computing system 104 for a computing task as a response to the request for benchmarking. For example, using the digital twin 104*, the energy management system 102 may determine energy consumptions associated with a plurality of different parameter configurations for the target computing system 104, and may select a particular parameter configuration for the target computing system 104. Additionally, or alternatively, the energy management system 102 may automatically assign a computing task to the target computing system 104 or schedule an order of task completion for a set of computing tasks to the target computing system 104 to optimize energy consumption associated with completing the computing task or set of computing tasks. As one example, the energy management system 102 may schedule high energy consumption computing tasks (or use of a high energy consumption target computing system 104) for an off-peak time (e.g., to reduce a cost associated with energy supply or to reduce a need for peaking power plant activation) and may schedule low energy consumption computing tasks (or use of a low energy consumption target computing system 104) for a peak time. Additionally, or alternatively, the energy management system 102 may use the energy consumption information to determine whether to assign one or more computing tasks to the target computing system 104, whether to have the one or more computing tasks completed concurrently or sequentially, or whether to assign a subset of resources of the target computing system 104 to the one or more computing tasks.

Additionally, or alternatively, the energy management system 102 may identify a carbon offset for a computing task based on a predicted energy consumption and associated carbon footprint. In this case, the energy management system 102 may automatically purchase or bid on the carbon offset in a carbon offset marketplace, thereby enabling carbon neutral computing for the target computing system 104. Additionally, or alternatively, the energy management system 102 may automatically turn the target computing system 104 on to complete the computing task and off when the energy management system 102 determines (e.g., based on monitoring) that the computing task is completed. In this way, the energy management system 102 avoids unnecessary energy consumption by the computing system.

Additionally, or alternatively, the energy management system 102 may migrate a workload or deployment based on the energy consumption information. For example, when the energy management system 102 is performing benchmarking for a usage context of a deployment migration or a workload migration, the energy management system 102 may determine a set of migration procedures to migrate the target computing system 104 (e.g., between cloud computing environments) or a computing task thereof to optimize energy consumption. Additionally, or alternatively, the energy management system 102 may recommend a change to a set of hardware components of the target computing system 104, based on identifying a particular hardware component as having a threshold contribution to energy consumption or being less than ideal in terms of energy consumption (e.g., another hardware component is available and is modeled to cause less energy consumption for the target computing system 104). Similarly, the energy management system 102 may recommend or automatically implement a change to a virtual machine or a software element.

As shown in FIG. 1G, as one example of recommendation generation, the energy management system 102 may generate a recommendation using the digital twin 104*. For example, the energy management system 102 may use a temporal pattern detection engine and an ontology class baselining engine to generate a baseline energy consumption for the target computing system 104 and identify a set of observed correlations between operating conditions or parameters of the target computing system 104 and energy consumption values for the target computing system 104. The energy management system 102 may store the baseline energy consumption in a baseline repository and the observed correlations in the observed correlation repository. In some implementations, the observed correlations may represent features of a machine learning model and the observed correlation repository may be implemented as a set of values of the machine learning model.

The energy management system 102 may monitor events occurring in connection with the digital twin 104* and may detect an anomaly using an anomaly detection engine. The anomaly detection engine may determine that an energy consumption or another metric associated with the digital twin 104* deviates from an expected baseline value, stored in the baseline repository, by a threshold amount. The energy management system 102 may determine a last stable status of the digital twin 104* using a last stable status determination engine. The last stable status determination engine may store sets of parameters of the digital twin 104* representing snapshots of a status of the digital twin 104* and may evaluate a set of snapshots to determine a set of parameters or a configuration of the digital twin 104* before a change or event that resulted in the anomaly. The energy management system 102 may use an impact analysis engine, an ontology class correlation engine, and a ranking engine to identify an impact of the anomaly, correlate the anomaly with one or more elements of the ontology (e.g., a hardware component, a software element, or a virtual machine), identify a set of root-cause candidates representing possible causes of the anomaly, and rank the set of root-cause candidates. In some implementations, the energy management system 102 may rank the set of root-cause candidates using a set of ranking rules stored in a ranking rules repository. The set of ranking rules may be generated during training of a machine learning model of anomaly detection. Similarly, the energy management system 102 may rank the set of root-cause candidates using results of an impact prediction machine learning (ML) model. For example, the energy management system 102 may feed the last stable status and/or a current status of the digital twin 104* into a trained model to identify a prediction of a root-cause of the anomaly.

The energy management system 102 may use an automated resolution engine to generate a set of candidate recommendations for resolving the root-cause of the anomaly. For example, the energy management system 102 may select candidate recommendations, from a configured actions repository, that correlate to resolution of one or more most-likely root-causes of the anomaly. The energy management system 102 may analyze the candidate recommendations using an impact analysis engine. For example, the energy management system 102 may use a candidate recommendation to alter the digital twin 104* and may simulate, using the digital twin 104*, an impact of the candidate recommendation. In this case, the energy management system 102 may determine an action-impact (e.g., a success score) of each candidate recommendation and store the action-impact in an action-impact repository. As described above, the energy management system 102 may provide information identifying the set of candidate recommendations, the set of action-impacts, or a selected recommendation for display via, for example, the client device 108. Additionally, or alternatively, the energy management system 102 may automatically implement one or more of the set of candidate recommendations.

As shown in FIG. 1H, as another example relating to recommendation generation, the energy management system 102 may obtain data for generating a recommendation using the digital twin 104*. For example, the energy management system 102 may use a temporal pattern detection engine and an ontology class baselining engine to generate a set of observed correlations between operating conditions or parameters of the target computing system 104 and energy consumption values for the target computing system 104. The energy management system 102 may store the observed correlations in the observed correlation repository.

The energy management system 102 may perform a similarity analysis of the observed correlations and other correlations observed for other digital twins associated with other projects stored in a projects repository. Based on the similarity analysis, the energy management system 102 may identify one or more similar projects (e.g., projects with similar ontologies, similar observed correlations, similar components, or similar industries), and may identify action-impacts stored for the one or more similar projects. In this case, the energy management system 102 can simulate applying recommendations associated with the action-impacts to the observed correlations for the digital twin 104* to determine whether a parameter configuration change can optimize energy consumption (e.g., reduce carbon footprint) of the target computing system 104 (or resolve an anomaly as described above). Additionally, or alternatively, the energy management system 102 can use the action-impacts to re-train or further train an impact prediction model, as described above, and store the re-trained or further trained impact prediction model for use in subsequent root-cause analysis and recommendation generation.

In some implementations, the energy management system 102 may generate a recommendation relating to a setting of the target computing system 104. For example, the energy management system 102 may use the digital twin 104* to simulate energy consumption metrics associated with a set of different candidate parameters for the target computing system 104 (e.g., quantities of virtual machines, operating hours, hardware configurations, etc.). In this case, the energy management system 102 may determine a best energy consumption metric associated with a best candidate parameter (e.g., a configuration of the target computing system 104 predicted to result in, for example, a minimum energy consumption value). The energy management system 102 may transmit information identifying the best candidate parameter and/or causing the target computing system 104 to change configurations to implement the best candidate parameter.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

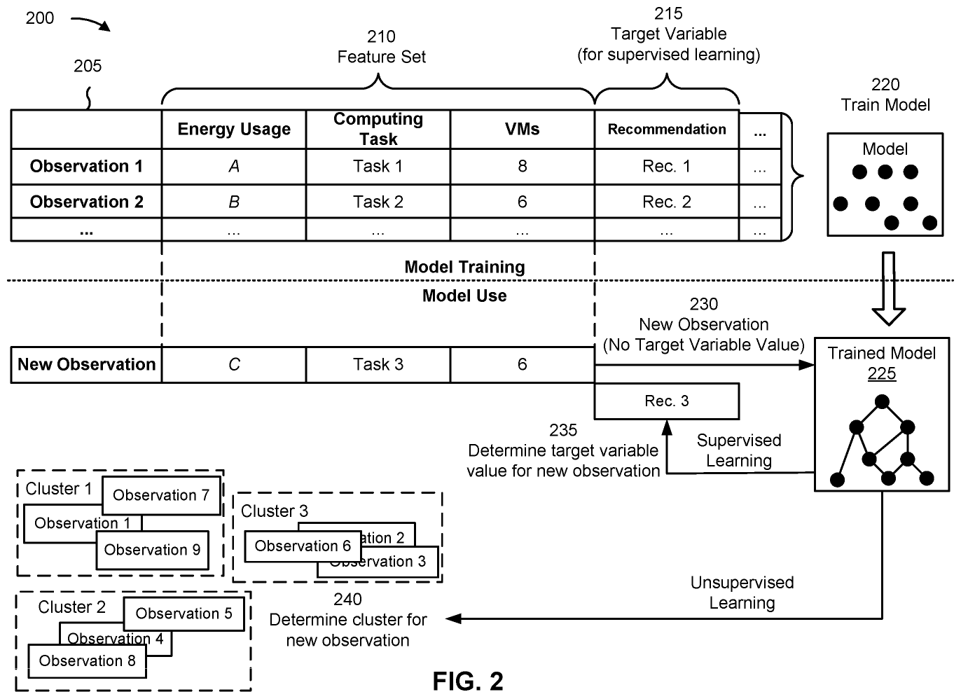

FIG. 2 is a diagram illustrating an example 200 of training and using a machine learning model in connection with computing system energy management. The machine learning model training and usage described herein may be performed using a machine learning system. The machine learning system may include or may be included in a computing device, a server, a cloud computing environment, or the like, such as the energy management system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the client device or the target computing system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the client device or the target computing system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of energy usage, a second feature of a computing task, a third feature of a quantity of virtual machines (VMs), and so on. As shown, for a first observation, the first feature may have a value of A, the second feature may have a value of Task 1, the third feature may have a value of 8, and so on. These features and feature values are provided as examples, and may differ in other examples. For example, the feature set may include one or more of the following features: a hardware vendor, a model number, a form factor type, a set of CPU characteristics, a quantity of hardware threads, a cache size, a memory amount, a power supply rating, a power supply type, a disc drive type, a quantity of network cards, a firmware setting, a network speed, a set of peripherals, performance data, power usage data, energy cost data, energy source data, a set of computing tasks for completion, a set of scenarios observed across a time series, a set of recommendations provided and/or implemented, or a result of providing and/or implementing the set of recommendations, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a recommendation (e.g., of one or more alterations to reduce or optimize an energy consumption, amount of produced emissions, or carbon footprint; of an order for completing computing tasks; of a site location for a computing system; or of a parameter setting for the computing system), which has a value of Rec. 1 for the first observation.

The feature set and target variable described above are provided as examples, and other examples may differ from what is described above. For example, for a target variable of a cause of an energy spike or an impact of implementing a recommendation, the feature set may include energy consumption values for a set of hardware components, software elements, or virtual machines; a set of configuration parameters for the set of hardware components, software elements, or virtual machines; or a set of previously identified energy spike root causes, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. When using a decision tree algorithm, the machine learning system may train a machine learning model to analyze data associated with features to determine a decision regarding, for example, a source of an energy spike or a recommendation to provide, given a set of input conditions (e.g., values for features). Additionally, or alternatively, when using a support vector machine algorithm, the machine learning system may train a machine learning model to classify different observed scenarios into a particular type and to provide recommendations corresponding to the particular type. Additionally, or alternatively, when using a neural network algorithm, the machine learning system may train a machine learning model to analyze a set of computing tasks and determine an assignment of the computing tasks to one or more computing systems in a generated order to achieve a minimized carbon footprint or energy consumption. After training, the machine learning system may store the machine learning model as a trained machine learning model 225 to be used to analyze new observations.

As an example, the machine learning system may obtain training data for the set of observations based on monitoring a set of computing systems. In this case, the machine learning system obtains parameter sets for the set of computing systems and monitors energy consumption during completion of sets of computing tasks. This enables the machine learning system to train a model to identify effects (e.g., to energy consumption) of changes to different parameters that can be configured for different computing systems, as well as effects of different types of computing systems being used to complete different tasks in different orders.

As shown by reference number 230, the machine learning system may apply the trained machine learning model 225 to a new observation, such as by receiving a new observation and inputting the new observation to the trained machine learning model 225. As shown, the new observation may include a first feature of energy usage, a second feature of a computing task, a third feature of a quantity of virtual machines, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of Rec. 3 (e.g., a particular recommendation of a set of possible recommendations or candidate recommendations) for the target variable of a recommendation for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, assigning the task to a particular computing system, ordering the task in a particular order, altering one or more parameters of the particular computing system (e.g., to optimize energy consumption), or purchasing carbon offsets in an amount equal to the predicted energy consumption, among other examples. The first automated action may include, for example, assigning the task to a particular computing system, ordering the task in a particular order, altering one or more parameters of the particular computing system (e.g., to optimize energy consumption), or purchasing carbon offsets in an amount equal to the predicted energy consumption, among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., the machine learning system classifies an observed energy consumption scenario into a cluster of energy spikes with a root cause of insufficient RAM being allocated for a computing task), then the machine learning system may provide a first recommendation, such as that additional RAM be allocated for the computing task. Additionally, or alternatively, the machine learning system may perform a first automated action and/or may cause a first automated action to be performed (e.g., by instructing another device to perform the automated action) based on classifying the new observation in the first cluster, such as automatically implementing the first recommendation described above.

As another example, if the machine learning system were to classify the new observation in a second cluster (e.g., the machine learning system classifies an observed energy consumption scenario into a cluster of energy spikes with a root cause of memory being allocated to already completed tasks), then the machine learning system may provide a second (e.g., different) recommendation (e.g., garbage collecting a memory to enable reallocation of existing memory resources to a computing task rather than increasing a memory allocation, which can cause excess energy usage) and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include an observed result (e.g., an energy consumption) of implementing a recommendation.

In this way, the machine learning system may apply a rigorous and automated process to manage energy utilization by a computing system, such as a cloud computing system or an on-premises data center, among other examples. The machine learning system may enable recognition and/or identification of tens, hundreds, thousands, or millions of features and/or feature values for tens, hundreds, thousands, or millions of observations, thereby increasing accuracy and consistency and reducing delay associated with energy management relative to requiring computing resources to be allocated for tens, hundreds, or thousands of operators to manually identifying causes of energy utilization using the features or feature values. Moreover, by improving energy management for computing systems, an overall energy usage and carbon footprint are reduced for the computing system.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an energy management system 301, which may include one or more elements of and/or may execute within a cloud computing system 302. The cloud computing system 302 may include one or more elements 303-312, as described in more detail below. As further shown in FIG. 3, environment 300 may include a network 320, an energy management system 301, a target computing system 330, and/or a client device 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the energy management system 301 may include one or more elements 303-312 of the cloud computing system 302, may execute within the cloud computing system 302, and/or may be hosted within the cloud computing system 302, in some implementations, the energy management system 301 may not be cloud-based (e.g., may be implemented outside of a cloud computing system) or may be partially cloud-based. For example, the energy management system 301 may include one or more devices that are not part of the cloud computing system 302, such as device 400 of FIG. 4, which may include a standalone server or another type of computing device. The energy management system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The target computing system 330 may include one or more elements of a cloud computing system, as described above, may execute within a cloud computing system, and/or may be hosted within a cloud computing system. In some implementations, the target computing system 330 may not be cloud-based (e.g., may be implemented outside of a cloud computing system, such as using an on-premises data center) or may be partially cloud-based. For example, the target computing system 330 may include one or more devices that are not part of a cloud computing system, such as device 400 of FIG. 4, which may include a standalone server or another type of computing device. The target computing system 330 may perform one or more operations and/or processes described in more detail elsewhere herein.

The client device 340 may include one or more devices capable of receiving, generating, storing, processing, and/or providing information associated with energy management for computing systems, as described elsewhere herein. The client device 340 may include a communication device and/or a computing device. For example, the client device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with energy management for computing systems. The device 400 may correspond to energy management system 301, target computing system 330, and/or the client device 340. In some implementations, energy management system 301, target computing system 330, and/or the client device 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

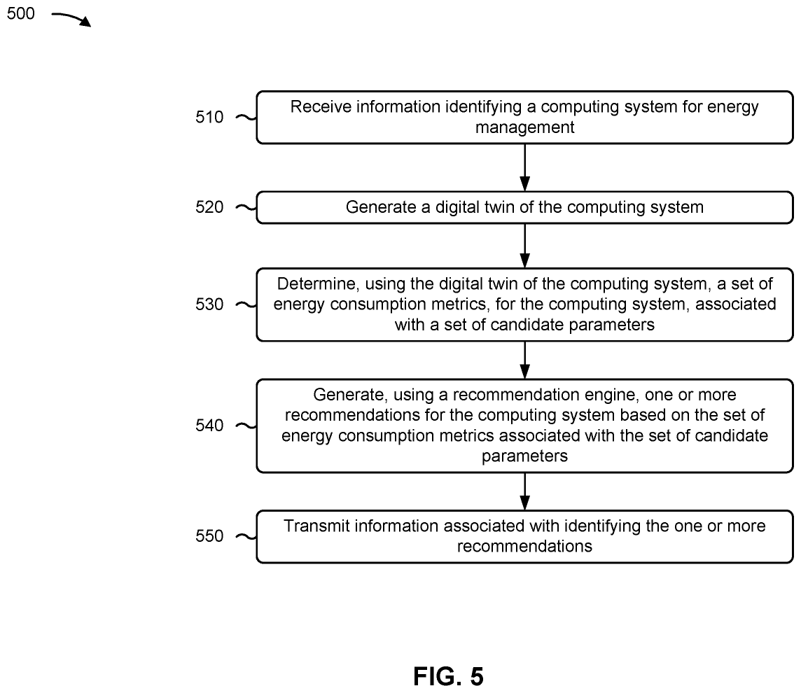

FIG. 5 is a flowchart of an example process 500 associated with decision engine for computing system energy management. In some implementations, one or more process blocks of FIG. 5 are performed by a device (e.g., the energy management system 301). In some implementations, one or more process blocks of FIG. 5 are performed by another device or a group of devices separate from or including the device, such as a target computing system (e.g., the target computing system 330) and/or a client device (e.g., the client device 340). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving information identifying a computing system for energy management (block 510). For example, the device may receive information identifying a computing system for energy management, as described above. In some implementations, the computing system may have a set of hardware components associated with first energy information, a set of virtual machines associated with second energy information, and a set of software entities associated with third energy information.

As further shown in FIG. 5, process 500 may include generating a digital twin of the computing system (block 520). For example, the device may generate a digital twin of the computing system using the first energy information for simulation of the set of hardware components, the second energy information for simulation of the set of virtual machines, and the third energy information for simulation of the set of software entities, as described above.

As further shown in FIG. 5, process 500 may include determining, using the digital twin of the computing system, a set of energy consumption metrics, for the computing system, associated with a set of candidate parameters (block 530). For example, the device may determine, using the digital twin of the computing system, a set of energy consumption metrics, for the computing system, associated with a set of candidate parameters, as described above.

As further shown in FIG. 5, process 500 may include generating, using a recommendation engine, one or more recommendations for the computing system based on the set of energy consumption metrics associated with the set of candidate parameters (block 540). For example, the device may generate, using a recommendation engine, one or more recommendations for the computing system based on the set of energy consumption metrics associated with the set of candidate parameters, as described above.

As further shown in FIG. 5, process 500 may include transmitting information associated with identifying the one or more recommendations (block 550). For example, the device may transmit information associated with identifying the one or more recommendations, as described above.

Process 500 may include additional implementations, such as any single implementation or any combination of implementations described below and/or in connection with one or more other processes described elsewhere herein.

In a first implementation, generating the digital twin comprises modeling one or more entities associated with at least one of a service characteristic, a project characteristic, a release characteristic, a code characteristic, or an energy characteristic.

In a second implementation, alone or in combination with the first implementation, generating the digital twin comprises identifying a set of energy providers for the computing system and a set of carbon intensity estimates associated with the set of energy providers.

In a third implementation, alone or in combination with one or more of the first and second implementations, determining the set of energy consumption metrics comprises determining a set of emissions metrics associated with the computing system.

In a fourth implementation, alone or in combination with one or more of the first through third implementations, determining the set of emissions metrics comprises determining a software carbon intensity associated with a computing task performable by the computing system.

In a fifth implementation, alone or in combination with one or more of the first through fourth implementations, determining the set of emissions metrics comprises generating a set of benchmarking scores for the set of emissions metrics, a benchmarking score, of the set of benchmarking scores, identifying a relative position of a corresponding emission metric, of the set of emissions metrics, in a range of candidate values for the corresponding emission metric.

In a sixth implementation, alone or in combination with one or more of the first through fifth implementations, generating the one or more recommendations comprises identifying, based on the set of energy consumption metrics for the set of candidate parameters, a best energy consumption metric associated with a best candidate parameter, and transmitting the information associated with identifying the one or more recommendations comprises transmitting information identifying the best candidate parameter, the one or more recommendations being related to implementing the best candidate parameter.

In a seventh implementation, alone or in combination with one or more of the first through sixth implementations, process 500 includes transmitting information associated with implementing the one or more recommendations.

In an eighth implementation, alone or in combination with one or more of the first through seventh implementations, generating the one or more recommendations comprises identifying a set of impacts of the set of candidate parameters, and selecting a recommendation, from a set of available recommendations, to select a particular candidate parameter, of the set of candidate parameters, based on the set of impacts of the set of candidate parameters.

In a ninth implementation, alone or in combination with one or more of the first through eighth implementations, generating the one or more recommendations comprises generating the one or more recommendations based at least in part on at least one of an anomaly detection function, a state determination function, an impact analysis function, a root cause analysis function, a ranking engine function, or a resolution engine function.

In a tenth implementation, alone or in combination with one or more of the first through ninth implementations, the set of candidate parameters relate to a set of deployment sites, and generating the one or more recommendations comprises selecting a deployment site, of the set of deployment sites, for the computing system based on the set of energy consumption metrics.

In an eleventh implementation, alone or in combination with one or more of the first through tenth implementations, the set of candidate parameters relate to a set of computing tasks, and generating the one or more recommendations comprises generating an assignment of a computing task, of the set of computing tasks, to the computing system based on the set of energy consumption metrics.

In a twelfth implementation, alone or in combination with one or more of the first through eleventh implementations, the set of candidate parameters relate to a set of possible configurations for the computing system, and generating the one or more recommendations comprises selecting a configuration, of the set of possible configurations, for the computing system.

In a thirteenth implementation, alone or in combination with one or more of the first through twelfth implementations, process 500 includes determining a set of updated energy consumption metrics associated with the set of candidate parameters based on the one or more recommendations, and selecting a particular recommendation, from the one or more recommendations, based on the set of updated energy consumption metrics, and transmitting the information associated with identifying the one or more recommendations comprises transmitting information identifying the particular recommendation.

In a fourteenth implementation, alone or in combination with one or more of the first through thirteenth implementations, process 500 includes monitoring actual energy consumption of the computing system, comparing the actual energy consumption of the computing system with a simulated energy consumption of the digital twin of the computing system, and updating one or more characteristics of the digital twin of the computing system based on comparing the actual energy consumption with the simulated energy consumption.

In a fifteenth implementation, alone or in combination with one or more of the first through fourteenth implementations, process 500 includes monitoring actual energy consumption of the computing system, and identifying a system anomaly associated with the computing system based on monitoring the actual energy consumption of the computing system and based on simulated energy consumption of the digital twin of the computing system, and generating the one or more recommendations comprises generating the one or more recommendations based on identifying the system anomaly.

In a sixteenth implementation, alone or in combination with one or more of the first through fifteenth implementations, generating the set of recommendations comprises identifying a carbon footprint associated with the computing system based on the set of energy consumption metrics, and identifying a set of carbon offsets for mitigating the carbon footprint.

In a seventeenth implementation, alone or in combination with one or more of the first through sixteenth implementations, process 500 includes automatically processing a transaction for the set of carbon offsets.

In an eighteenth implementation, alone or in combination with one or more of the first through seventeenth implementations, process 500 includes detecting, based on the set of energy consumption metrics, a threshold change to an energy consumption of the computing system, and generating the one or more recommendations comprises predicting a component, of the set of hardware components, the set of virtual machines, or the set of software entities, responsible for the threshold change to the energy consumption, and generating a recommendation for mitigating the threshold change to the energy consumption based on predicting the component responsible for the threshold change to the energy consumption.

In a nineteenth implementation, alone or in combination with one or more of the first through eighteenth implementations, generating the one or more recommendations comprises generating a recommendation for optimizing energy consumption of the computing system across a set of computing tasks.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, information identifying a computing system for energy management, the computing system having a set of hardware components associated with first energy information, a set of virtual machines associated with second energy information, and a set of software entities associated with third energy information;
generating, by the device, a digital twin of the computing system using the first energy information for simulation of the set of hardware components, the second energy information for simulation of the set of virtual machines, and the third energy information for simulation of the set of software entities;
determining, by the device and using the digital twin of the computing system, a set of energy consumption metrics, for the computing system, associated with a set of candidate parameters;
generating, by the device and using a recommendation engine, one or more recommendations for the computing system based on the set of energy consumption metrics associated with the set of candidate parameters; and
transmitting, by the device, information associated with identifying the one or more recommendations.

2. The method of claim 1, wherein generating the digital twin comprises:
modeling one or more entities associated with at least one of:
a service characteristic,
a project characteristic,
a release characteristic,
a code characteristic, or
an energy characteristic.

3. The method of claim 1, wherein generating the digital twin comprises:
identifying a set of energy providers for the computing system and a set of carbon intensity estimates associated with the set of energy providers.

4. The method of claim 1, wherein determining the set of energy consumption metrics comprises:
determining a set of emissions metrics associated with the computing system.

5. The method of claim 4, wherein determining the set of emissions metrics comprises:
determining a software carbon intensity associated with a computing task performable by the computing system.

6. The method of claim 4, wherein determining the set of emissions metrics comprises:
generating a set of benchmarking scores for the set of emissions metrics, a benchmarking score, of the set of benchmarking scores, identifying a relative position of a corresponding emission metric, of the set of emissions metrics, in a range of candidate values for the corresponding emission metric.

7. The method of claim 1, wherein generating the one or more recommendations comprises:
identifying, based on the set of energy consumption metrics for the set of candidate parameters, a best energy consumption metric associated with a best candidate parameter; and
wherein transmitting the information associated with identifying the one or more recommendations comprises:
transmitting information identifying the best candidate parameter, the one or more recommendations being related to implementing the best candidate parameter.

8. A device for wireless communication, comprising:
one or more memories; and
one or more processors, communicatively coupled to the one or more memories, configured to:
receive information identifying a computing system for energy management, the computing system having a set of hardware components associated with first energy information, a set of virtual machines associated with second energy information, and a set of software entities associated with third energy information;
generate a digital twin of the computing system using the first energy information for simulation of the set of hardware components, the second energy information for simulation of the set of virtual machines, and the third energy information for simulation of the set of software entities;
determine, using the digital twin of the computing system, a set of energy consumption metrics, for the computing system, associated with a set of candidate parameters;
generate, using a recommendation engine, one or more recommendations for the computing system based on the set of energy consumption metrics associated with the set of candidate parameters; and
transmit information associated with implementing the one or more recommendations.

9. The device of claim 8, wherein the one or more processors, to generate the one or more recommendations, are configured to:
identify a set of impacts of the set of candidate parameters; and
select a recommendation, from a set of available recommendations, to select a particular candidate parameter, of the set of candidate parameters, based on the set of impacts of the set of candidate parameters.

10. The device of claim 8, wherein the one or more processors, to generate the one or more recommendations, are configured to:
generate the one or more recommendations based at least in part on at least one of:
an anomaly detection function,
a state determination function,
an impact analysis function,
a root cause analysis function,
a ranking engine function, or
a resolution engine function.

11. The device of claim 8, wherein the set of candidate parameters relate to a set of deployment sites; and
wherein the one or more processors, to generate the one or more recommendations, are configured to:
select a deployment site, of the set of deployment sites, for the computing system based on the set of energy consumption metrics.

12. The device of claim 8, wherein the set of candidate parameters relate to a set of computing tasks; and
wherein the one or more processors, to generate the one or more recommendations, are configured to:
generate an assignment of a computing task, of the set of computing tasks, to the computing system based on the set of energy consumption metrics.

13. The device of claim 8, wherein the set of candidate parameters relate to a set of possible configurations for the computing system; and
wherein the one or more processors, to generate the one or more recommendations, are configured to:
select a configuration, of the set of possible configurations, for the computing system.

14. A non-transitory computer-readable medium storing a set of instructions for wireless communication, the set of instructions comprising:
one or more instructions that, when executed by one or more processors of a device, cause the device to:
receive information identifying a computing system for energy management, the computing system having a set of hardware components associated with first energy information, a set of virtual machines associated with second energy information, and a set of software entities associated with third energy information;
generate a digital twin of the computing system using the first energy information for simulation of the set of hardware components, the second energy information for simulation of the set of virtual machines, and the third energy information for simulation of the set of software entities;
determine, using the digital twin of the computing system, a set of energy consumption metrics, for the computing system, associated with a set of candidate parameters;
generate, using a recommendation engine, one or more recommendations for the computing system based on the set of energy consumption metrics associated with the set of candidate parameters; and
determine a set of updated energy consumption metrics associated with the set of candidate parameters based on the one or more recommendations; and
select a particular recommendation, from the one or more recommendations, based on the set of updated energy consumption metrics; and
transmit information identifying the particular recommendation.

15. The non-transitory computer-readable medium of claim 14, wherein the one or more instructions further cause the device to:
monitor an actual energy consumption of the computing system;
compare the actual energy consumption of the computing system with a simulated energy consumption of the digital twin of the computing system; and
update one or more characteristics of the digital twin of the computing system based on comparing the actual energy consumption with the simulated energy consumption.

16. The non-transitory computer-readable medium of claim 14, wherein the one or more instructions further cause the device to:
monitor an actual energy consumption of the computing system; and
identify a system anomaly associated with the computing system based on monitoring the actual energy consumption of the computing system and based on simulated energy consumption of the digital twin of the computing system; and
wherein the one or more instructions, that cause the device to generate the one or more recommendations, cause the device to:
generate the one or more recommendations based on identifying the system anomaly.

17. The non-transitory computer-readable medium of claim 14, wherein the one or more instructions further cause the device to:
identify a carbon footprint associated with the computing system based on the set of energy consumption metrics; and
identify a set of carbon offsets for mitigating the carbon footprint.

18. The non-transitory computer-readable medium of claim 17, wherein the one or more instructions further cause the device to:
automatically process a transaction for the set of carbon offsets.

19. The non-transitory computer-readable medium of claim 14, wherein the one or more instructions further cause the device to:
detect, based on the set of energy consumption metrics, a threshold change to an energy consumption of the computing system; and
wherein the one or more instructions, that cause the device to generate the one or more recommendations, cause the device to:
predict a component, of the set of hardware components, the set of virtual machines, or the set of software entities, responsible for the threshold change to the energy consumption; and
generate a recommendation for mitigating the threshold change to the energy consumption based on predicting the component responsible for the threshold change to the energy consumption.

20. The non-transitory computer-readable medium of claim 14, wherein the one or more instructions, that cause the device to generate the one or more recommendations, cause the device to:
generate a recommendation for optimizing energy consumption of the computing system across a set of computing tasks.
